(19) United States
(12) Patent Application Publication
(10) Pub. No.: US 2023/0199194 A1
(43) Pub. Date: Jun. 22, 2023

(54) VIDEO PROCESSING DEVICE, VIDEO PROCESSING METHOD, AND RECORDING MEDIUM

(71) Applicant: NEC CORPORAITON, Minato-ku, Tokyo (JP)

(72) Inventors: Soma SHIRAISHI, Tokyo (JP); Katsumi Kikuchi, Tokyo (JP); Yu Nabeto, Tokyo (JP); Haruna Watanabe, Tokyo (JP)

(73) Assignee: NEC CORPORAITON, Minato-ku, Tokyo (JP)

(21) Appl. No.: 17/926,694

(22) PCT Filed: May 27, 2020
(86) PCT No.: PCT/JP2020/020868

§ 371 Date: Nov. 21, 2022

(51) Int. Cl. H04N 19/142; H04N 21/44; H04N 21/845; H04N 19/87

(52) U.S. Cl. CPC H04N 19/142; H04N 21/44008; H04N 21/8456; H04N 19/87

(57) ABSTRACT

In the video processing device, the video acquisition means acquires a material video. The audience scene extraction means extracts an audience scene showing an audience from the material video. The important scene extraction means extracts an important scene from the material video. The association means associates the audience scene with the important scene. The generation means generates a digest video including the important scene and the audience scene associated with the important scene.

### TECHNICAL FIELD

The present invention relates to processing of video data.

### BACKGROUND ART

There has been proposed a technique for generating a video digest from moving images. Patent Document 1 discloses a highlight extraction device that creates learning data files from a training moving image prepared in advance and important scene moving images specified by a user, and detects important scenes from a target moving image based on the learning data files.

### PRECEDING TECHNICAL REFERENCES

### Patent Document

Patent Document 1: Japanese Patent Application Laid-Open under No. JP 2008-022103

### SUMMARY

### Problem to be Solved by the Invention

When a digest video is created from a video of a sport game, not only the video of the players but also the video of the audience in the audience stand or the message board held by the audience are often included in the digest video edited by the human. However, since such scenes of the audience are smaller in number than the scenes of the players, it is difficult to learn them as important scenes by machine learning and it is difficult to include them in the digest video.

It is an object of the present invention to provide a video processing device capable of generating a digest video including audience scenes in a sport video.

### Means for Solving the Problem

According to an example aspect of the present invention, there is provided a video processing device comprising:

a video acquisition means configured to acquire a material video;

an audience scene extraction means configured to extract an audience scene showing an audience from the material video;

an important scene extraction means configured to extract an important scene from the material video;

an association means configured to associate the audience scene with the important scene; and

a generation means configured to generate a digest video including the important scene and the audience scene associated with the important scene.

According to another example aspect of the present invention, there is provided a video processing method comprising:

acquiring a material video;

extracting an audience scene showing an audience from the material video;

extracting an important scene from the material video;

associating the audience scene with the important scene; and

generating a digest video including the important scene and the audience scene associated with the important scene.

According to still another example aspect of the present invention, there is provided a recording medium recording a program that causes a computer to perform processing comprising:

acquiring a material video;

extracting an audience scene showing an audience from the material video;

extracting an important scene from the material video;

associating the audience scene with the important scene; and

generating a digest video including the important scene and the audience scene associated with the important scene.

### Effect of the Invention

According to the present invention, it is possible to generate a digest video including audience scenes in a sport video.

### BRIEF DESCRIPTION OF THE DRAWINGS

FIG. 1 illustrates an overall configuration of a digest generation device according to an example embodiment.

FIG. 2 illustrates an example of a digest video.

FIGS. 3A and 3B illustrate configurations of the digest generation device at the time of training and inference.

FIG. 4 is a block diagram illustrating a hardware configuration of a digest generation device.

FIGS. 5A and 5B are examples of a video of an audience stand.

FIG. 6 schematically shows a method for including audience scenes in a digest video.

FIG. 7 shows a functional configuration of a digest generation device according to a first example embodiment.

FIG. 8 is a flowchart of digest generation processing.

FIG. 9 is a flowchart of audience scene extraction processing.

FIG. 10 shows a functional configuration of a training device of an audience scene extraction model.

FIG. 11 is a flowchart of training processing.

FIG. 12 is a block diagram showing a functional configuration of a video processing device according to a second example embodiment.

### EXAMPLE EMBODIMENTS

Preferred example embodiments of the present invention will be described with reference to the accompanying drawings.

### Basic Configuration

First, a basic configuration of the digest generation device according to the example embodiments will be described.

### Overall Configuration

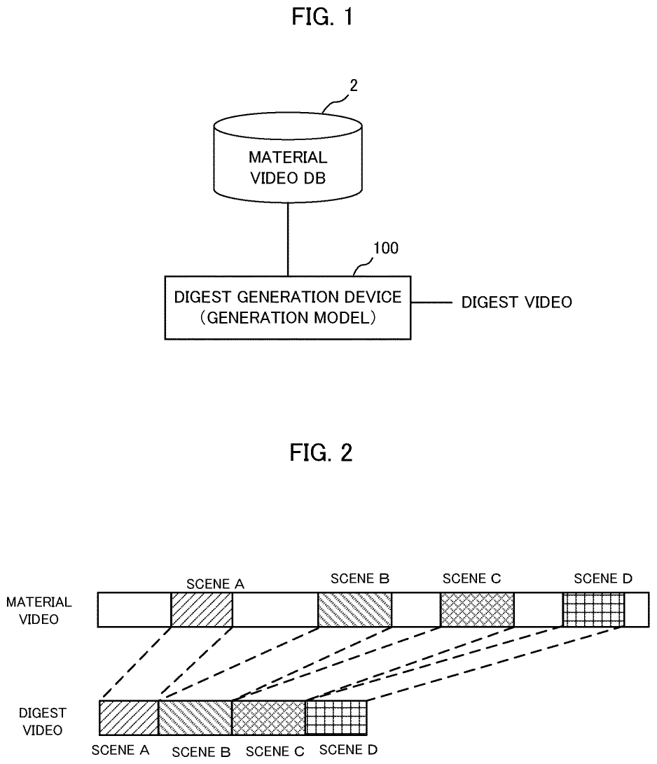

FIG. 1 illustrates an overall configuration of the digest generation device 100 according to the example embodiments. The digest generation device 100 is connected to a material video database (hereinafter, “database” is also referred to as “DB”) 2. The material video DB 2 stores various material videos, i.e., moving images. For example, the material video may be a video such as a television program broadcasted from a broadcasting station, a video that is distributed on the Internet, and the like. It is noted that the material video may or may not include sound.

The digest generation e ice 100 generates a digest video using multiple portions of the material video stored in the material video DB 2, and outputs the digest video. The digest video is a video generated by connecting important scenes in the material video in time series. The digest generation device 100 generates a digest video using a digest generation model (hereinafter simply referred to as “generation model”) trained by machine learning. For example, as the generation model, a model using a neural network can be used.

FIG. 2 shows an example of a digest video. In the example of FIG. 2, the digest generation device 100 extracts scenes A to D included in the material video as the important scenes, and generates a digest video by connecting the important scenes in time series. Incidentally, the important scene extracted from the material video may be repeatedly used in the digest video in dependence upon its content,

[Functional Configuration]

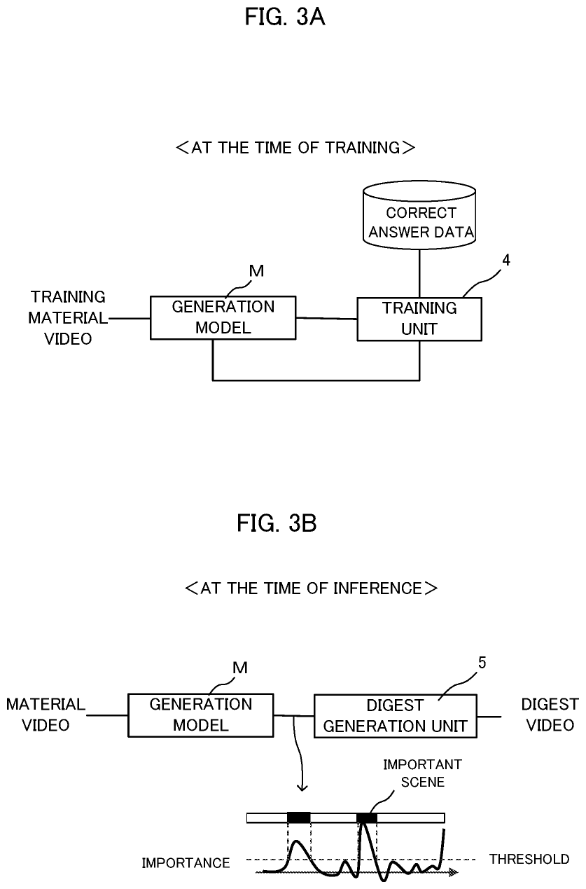

FIG. 3A is a block diagram illustrating a configuration for training a generation model, used by the digest generation device 100. A training dataset prepared in advance is used to train the generation model. The training dataset is a pair of a training material video and correct answer data showing a correct answer for the training material video. The correct answer data is data obtained by giving a tag (hereinafter referred to as “a correct answer tag”) indicating the correct answer to the position of the important scene in the training material video. Typically, giving the correct answer tags to the correct answer data is performed by an experienced editor or the like. For example, for a material video of baseball broadcasting, a baseball commentator or the like selects highlight scenes during the game and give the correct answer tags. Also, the correct answer tag may be automatically given by learning a method of giving the correct answer tags by the editor using machine learning or the like.

At the time of training, the training material video is inputted to the generation model M. The generation model M extracts the important scenes from the material video. Specifically, the generation model M extracts the feature quantity from one frame or a set of multiple frames forming the material video, and calculates the importance (importance score) for the material video based on the extracted feature quantity. Then, the generation model M outputs a portion where the importance is equal to or higher than a predetermined threshold value as an important scene. The training unit 4 optimizes the generation model M using the output of the generation model M and the correct answer data. Specifically, the training unit 4 compares the important scene outputted by the generation model M with the scene indicated by the correct answer tag included in the correct answer data, and updates the parameters of the generation model M so as to reduce the error (loss). The trained generation model M thus obtained can extract scenes close to the scene to which the editor gives the correct answer tag as an important scene from the material video.

FIG. 3B illustrates a configuration of the digest generation device 100 at the time of inference. At the time of inference, the material video subjected to the generation of the digest video is inputted to the trained generation model M. The generation model M calculates the importance from the material video, extracts the portions where the importance is equal to or higher than a predetermined threshold value as the important scenes, and outputs them to the digest generation unit 5. The digest generation unit 5 generates and outputs a digest video by connecting the important scenes extracted by the generation model M. In this way, the digest generation device 100 generates a digest video from the material video using the trained generation model M.

[Hardware Configuration]

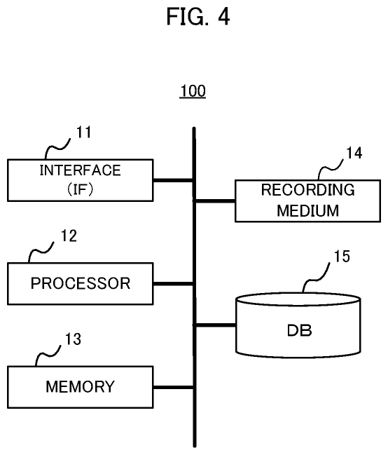

FIG. 4 is a block diagram illustrating a hardware configuration of the digest generation device 100. As illustrated, the digest generation device 100 includes an interface (IF) 11, a processor 12, a memory 13, a recording medium 14, and a DB 15.

The IF 11 inputs and outputs data to and from external devices. Specifically, the material video stored in the material video DB 2 is inputted to the digest generation device 100 via the IF 11. Further, the digest video generated by the digest generation device 100 is outputted to an external device through the IF 11.

The processor 12 is a computer, such as a CPU (Central Processing Unit), and controls the entire digest generation device 100 by executing a previously prepared program. Specifically, the processor 12 executes training processing and digest generation processing which will be described later.

The memory 13 is a ROM (Read Only Memory), a RAM (Random Access Memory), and the like. The memory 13 is also used as a work memory during the execution of various processing by the processor 12.

The recording medium 14 is a non-volatile, non-transitory recording medium such as a disk-shaped recording medium, a semiconductor memory, or the like, and is configured to be detachable from the digest generation device 100. The recording medium 14 records various programs to be executed by the processor 12. When the digest generation device 100 executes various kinds of processing, the program recorded on the recording medium 14 is loaded into the memory 13 and executed by the processor 12.

The database 15 temporarily stores the material video inputted through the IF 11, the digest video generated by the digest generation device 100, and the like. The database 15 also stores information on the trained generation model used by the digest generation device 100, and the training dataset used for training the generation models. Incidentally, the digest generation device 100 may include an input unit such as a keyboard and a mouse, and a display unit such as a liquid crystal display for the editor to perform instructions and inputs.

### First Example Embodiment

Next, a first example embodiment of the present invention will be described.

[Principles]

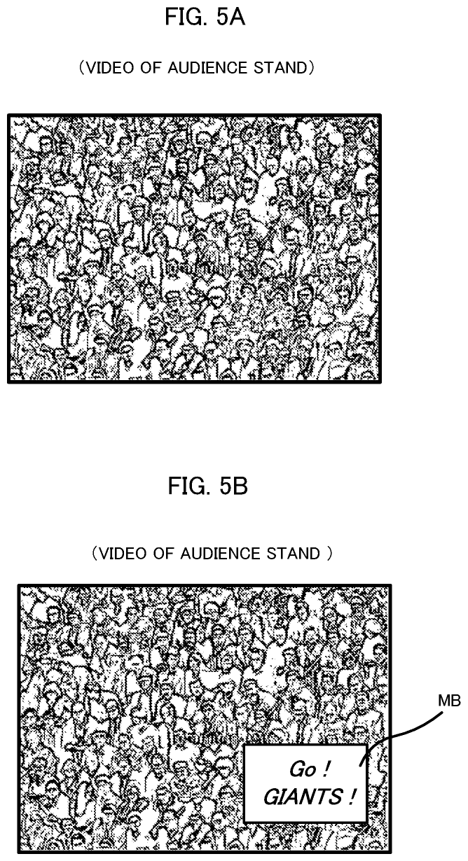

In the first example embodiment, when generating a digest video from a material video such as a game video of sports, the digest generation device 100 extracts a scene showing the audience stand (hereinafter, referred to as “audience scene”) and includes it in the digest video. At this time, it is characteristic that the digest generation device 100 includes the audience scene extracted from the material video in the digest video in association with the important scene extracted from the material video. FIG. 5A shows an example of a video of the audience stand. This video is a moving image of the audience stand including a large number of audiences.

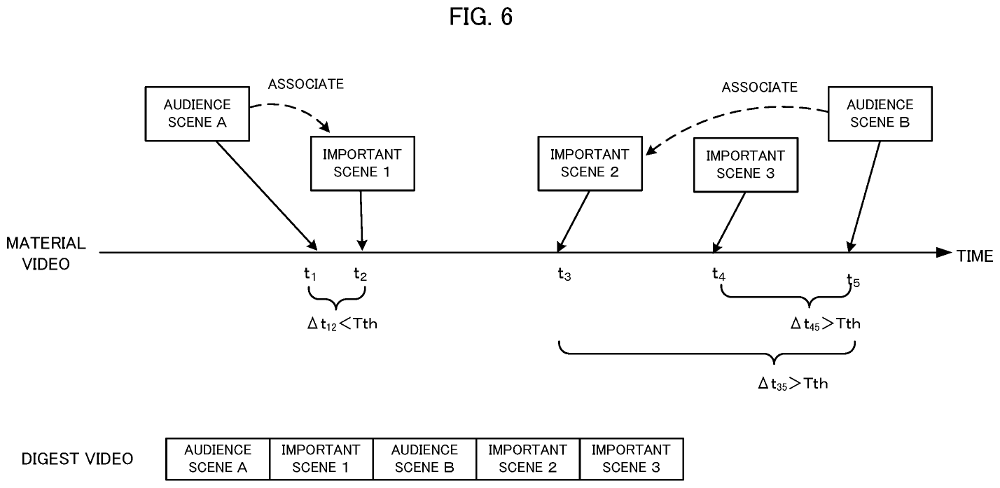

FIG. 6 schematically shows a method for including audience scenes in a digest video. In FIG. 6, the time in the material video is shown on the horizontal axis. The digest generation device 100 extracts audience scenes by pre-processing from the material video. In the example of FIG. 6, it is assumed that the audience scenes A and B are extracted from the material video. Also, the digest generation device 100 extracts important scenes from the material video in the manner described above. In the example of FIG. 6, it is assumed that the important scenes 1-3 are extracted from the material video. In this case, the digest generation device 100 associates the audience scenes A and B to any of the important scenes. Then, when the audience scenes are associated, the digest generation device 100 places the audience scenes before or after the associated important scene on the time axis to produce a digest video.

A Method for associating an audience scene to an important scene is as follows:

(1) First Method

The first method associates an audience scene to an important scene based on the time in the material video. Specifically, the first method associates an audience scene to an important scene which is the closest in time in the material video. Incidentally, an audience scene may be associated with an important scene only when the time interval (time difference) between the audience scene and the important scene is equal to or smaller than a predetermined threshold value. In this case, if the time interval between the audience scene and the important scene closest to the audience scene is larger than the threshold, the audience scene is not associated with the important scene.

Incidentally, when associating the audience scene by the first method, it is preferable that the positional relationship of the audience scene with respect to the important scene follows the positional relationship between the audience scene and the important scene in the material video. In the example of FIG, 6, since the audience scene A is earlier than the important scene 1 in the material video, the audience scene A is placed before the important scene 1 as shown in the example of the digest video. Conversely, if the audience scene is later than the important scene to be associated in the material video, the audience scene is placed after the important scene.

(2) Second Method

The second method extracts information about color from the audience scene and uses it to associate the audience scene with the important scene. Specifically, the digest generation device 100 recognizes the colors of clothing, hats, and the like worn by people included in the audience scene extracted from the material video, or the colors of objects (e.g., megaphones, cheering flags, etc.) that those people are holding, and extracts information about the colors that occupy a large part of the audience stand.

Typically, sports teams have specific team colors, and the players wear uniforms of their team color. In addition, fans of that team often watch games wearing shirts, hats, etc. of the same or similar design as the uniform of that team. Also, fans often cheer the team with supporting goods such as megaphones and cheering flags of the team color. Therefore, the digest generation device 100 acquires information about the color from the audience scene and associates the audience scene with the important scene of the team having a team color identical or similar to that color. For example, it is assumed that the material video is a game between the team A and the team B, wherein the team color of the team A is red and the team color of the team B is blue. In this case, the digest generation device 100 associates the audience scene, in which the majority of the audience stand is occupied by red, with the important scene relating to the team A (e.g., the scoring scene of the team A), and associates the audience scene, in which the majority of the audience stand is occupied by blue, with an important scene relating to the team B.

When multiple audience scenes and multiple important scenes are extracted for a certain team, there are several ways to select the important scenes to which the audience scenes are associated. For example, each audience scene may be associated with an important scene that is closest in time to that team's important scene. Also, each audience scene may be associated with an important scene randomly selected from the multiple important scenes of the team.

(3) Third Method

The third method extracts information about a character string from the audience scene and uses it to associate the audience scene with the important scene. Specifically, the digest generation device 100 recognizes a character string such as a support message written on a message board, a placard, a cheering flag, or the like included in the audience scene extracted from the material video, and associates the audience scene with the important scene related to the character string.

Specifically, when a team name, a player name, a uniform number of a player, or the like is written on a message board appearing the audience scene, the digest generation device 100 associates the audience scene with the important scene of the team indicated by the character string or the team to which the player indicated by the character string belongs. For example, as shown in FIG. 5B, if the message board “Go! GIANTS!” is written on the message board appearing in the audience scene, the digest generation device 100 associates this audience scene with the important scene of the team “GIANTS”.

In the third method, if multiple audience scenes and multiple important scenes are extracted, the digest generation device 100 may associate each audience scene with the important scene that is closest in time among the important scenes of that team, or with an important scene randomly selected from the multiple important scenes of that team.

In the example of FIG. 6, the digest generation device 100 associates the audience scene A with the important scene 1 by the first method and places it before the important scene 1. As to the audience scene A, since the time interval Δt₁₂ between the time t₁ of the audience scene A and the time t₂ of the important scene in the material video is smaller than the predetermined threshold Tth, the audience scene A is associated with the important scene 1. On the other hand, as to the audience scene B, since both the time interval Δt₃₅ between the audience scene B and the important scene 2 and the time interval Δt₄₅ between the audience scene B and the important scene 3 are larger than the predetermined threshold Tth, the audience scene B is not associated with the important scene by the first method. However, in the example of FIG. 6, the audience scene B is associated with the important scene 2 by one of the second method or the third method.

Incidentally, any one of the first to third methods described above may be used, or two or more of them may be used in combination. When two or more of them are used in combination, the priority can be arbitrarily determined. In addition, it is not necessary that the digest generation device 100 associates all the audience scenes extracted from the material video with the important scenes and includes them in the digest video. If there are many audience scenes, some of them may be selected and associated with the important scenes to be included in the digest video. Further, only the audience scenes that are associated by one or more of the above-described first to third methods may be included in the digest video, and the audience scenes that are not associates may be excluded from the digest video.

[Digest Generation Device]

(Functional Configuration)

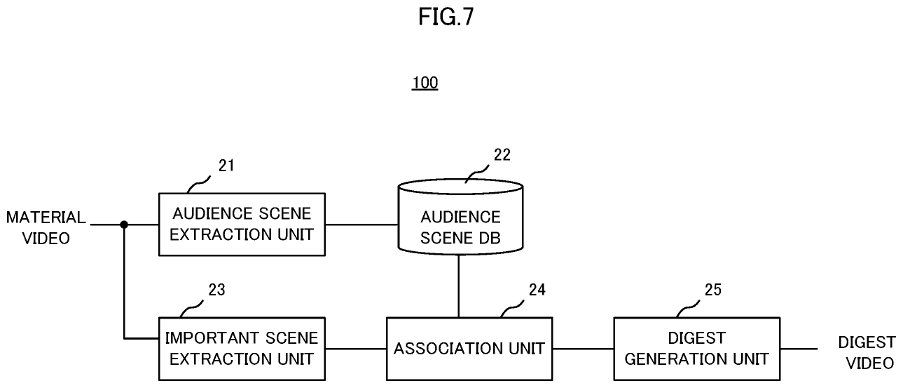

FIG. 7 is a block diagram showing functional configuration of the digest generation device 100 according to the first example embodiment. The digest generation device 100 includes an audience scene extraction unit 21, an audience scene DB 22, an important scene extraction unit 23, an association unit 24, and a digest generation unit 25.

The material video is inputted to the audience scene extraction unit 21 and the important scene extraction unit 23. The audience scene extraction unit 21 extracts the audience scenes from the material video and stores them in the audience scene DB 22. The audience scene is the video showing the audience stand in the video of sport games. The audience scene extraction unit 21 extracts the audience scene using a pre-trained model using a neural network, for example. The model training method will be described later. The audience scene extraction unit 21 extracts the audience scenes from the material video as the preprocessing for generating a digest video and stores them in the audience scene DB 22. Incidentally, the audience scene extraction unit 21 also extracts the time information of each audience scene used in the first method described above as the additional information, and stores them in the audience scene DB 22 in association with the audience scenes. The audience scene extraction unit 21 also extracts information relating to the color used in the second method or the information relating to the character string used in the third method as the additional information, and stores the information in the audience scene DB 22 in association with the audience scenes.

The important scene extraction unit 23 extracts important scenes from the material video by the method described with reference to FIG. 3, and outputs them to the association unit 24. The association unit 24 associates the audience scenes stored in the audience scene DB 22 with the important scenes extracted by the important scene extraction unit 23. Specifically, the association unit 24 associates the audience scenes with the important scenes using one or a combination of the aforementioned first to third methods, and outputs them to the digest generation unit 25. Incidentally, the association unit 24 outputs a pair of the audience scene and the important scene to the digest generation unit 25 for the important scene with which the audience scene is associated, and outputs only the important scene to the digest generation unit 25 for the important scene with which the audience scene is not associated.

The digest generation unit 25 generates a digest video by connecting the important scenes inputted from the association unit 24 in time series. At that time, the digest generation unit 25 inserts the audience scenes before or after the associated important scenes. Incidentally, the association unit 24 may generate arrangement information indicating whether to place each audience scene either before or after the important scene, and outputs the arrangement information to the digest generation unit 25 together with the audience scenes and the important scenes. In this case, the digest generation unit 25 may determine the insertion position of the audience scenes with reference to the inputted arrangement information. Thus, the digest generation unit 25 generates and outputs a digest video including the audience scenes.

(Digest Video Generation Processing)

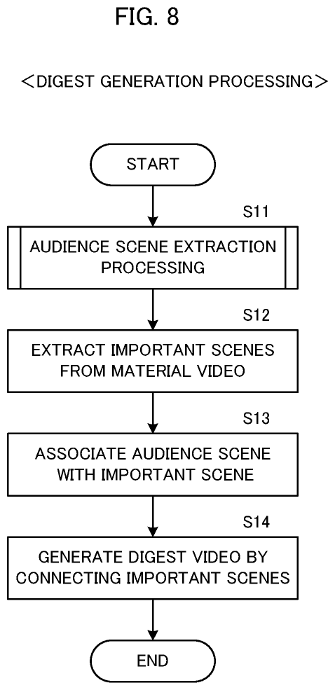

FIG. 8 is a flowchart of the digest generation processing executed by the digest generation device 100. This processing is realized by processor 12 shown in FIG. 4, which executes a program prepared in advance and operates as each element shown in FIG. 7.

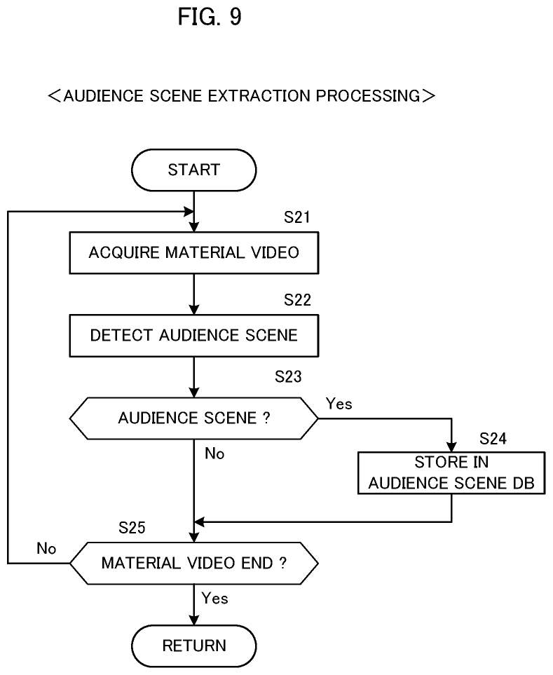

First, the audience scene extraction unit 21 performs audience scene extracting processing as a preprocessing (step S11). FIG. 9 is a flowchart of the audience scene extraction processing. First, the audience scene extraction unit 21 acquires the material video (step S21), and detects the audience scene from the material video (step S22). When the audience scene is detected (step S23: Yes), the audience scene extraction unit 21 stores it in the audience scene DB 22 (step S24). Next, the audience scene extraction unit 21 determines whether or not the processing of steps S21 to S24 has been performed to the end of the material video (step S25). When the processing of steps S21 to 24 has not been performed to the end, the audience scene extraction unit 21 repeats steps S21 to S24. When the audience scene extraction unit 21 executes the processing of steps S21 to S24 to the end of the material video (step S25: Yes), the processing ends. Thus, the audience scenes are extracted from the material video. Further, as the additional information of the audience scene, the time of each audience scene, and information about the color or the character string included in the audience scene are acquired.

Returning to FIG. 8 the important scene extraction unit 23 extracts important scenes from the material video (step S12). Next, the association unit 24 associates the audience scenes stored in the audience scene DB 22 with the extracted important scenes using one or more of the aforementioned first to third methods (step S13). The association unit 24 outputs the important scenes with which the audience scene is associated and the important scenes with which the audience scene is not associated, to the digest generation unit 25. Then, the digest generation unit 25 generates a digest video by connecting the important scenes in time series and inserting the audience scenes before or after the important scenes (step S14). Thus, the digest video generation processing ends.

[Training Device]

Next, the training of the audience scene extraction model used by the audience scene extraction unit 21 will be described. FIG. 19 shows a functional configuration of a training device that trains an audience scene extraction model Mx. The training device 200 includes an audience scene extraction model Mx and a training unit 4x. Also, a training dataset is prepared for the training of audience scene extraction model. Mx. The training dataset includes the training material videos and the correct answer data. The correct answer data is data in which a correct answer tags indicating the correct answers are given to the audience scenes included in the training material video.

The training material videos are inputted to the audience scene extraction model Mx. The audience scene extraction model Mx extracts feature quantities from the inputted training material videos, extracts the audience scenes based on the feature quantities, and outputs them to the training unit 4x. The training unit 4x optimizes the audience scene extraction model Mx using the audience scenes outputted by the audience scene extraction model Mx and the correct answer data. Specifically, the training unit 4x calculates the loss by comparing the audience scenes extracted by the audience scene extraction model Mx with the scenes to which the correct tags are given, and updates the parameters of the audience scene extraction model Mx so that the loss becomes small. Thus, a trained audience scene extraction model Mx is obtained.

(Training Process)

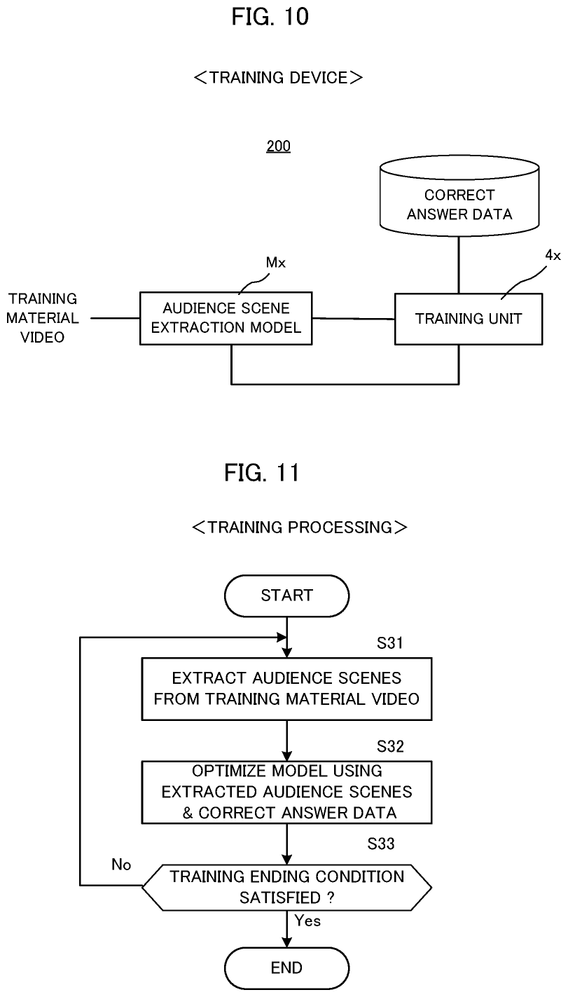

FIG. 11 is a flowchart of training processing by the training device 200. This processing is actually realized by the processor 12 shown in FIG. 4, which executes a program prepared in advance and operates as each element shown in FIG. 10. First, the audience scene extraction model Mx extracts the audience scenes from the training material video (step S31). Next, the training unit 4x optimizes the audience scene extraction model using the audience scenes outputted from the audience scene extraction model. Mx and the correct answer data (step S32).

Next, the training device 200 determines whether or not the training ending condition is satisfied (step S33). The training ending condition is, for example, that the training dataset prepared in advance is used, that the value of the loss calculated by the training unit 4x converged within a predetermined range, and the like. Training of the audience scene extraction model Mx is performed until the training ending condition is satisfied. When the training ending condition is satisfied, the training processing ends.

### Second Example Embodiment

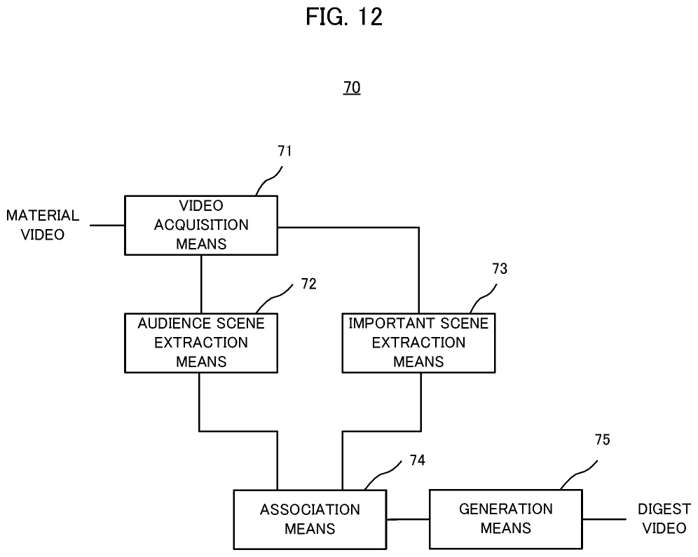

Next, a second example embodiment of the present invention will be described. FIG. 12 is a block diagram showing a functional configuration of the video processing device according to the second example embodiment. As illustrated, the video processing device includes a video acquisition means 71, an audience scene extraction means 72, an important scene extraction unit 73, an association means 74 and a generation means 75. The video acquisition means 71 acquires a material video. The audience scene extraction means 72 extracts an audience scene showing an audience from the material video. The important scene extraction means 73 extracts an important scene from the material video. The association means 74 associates the audience scene with the important scene. The generation means 75 generates a digest video including the important scene and the audience scene associated with the important scene.

A part or all of the example embodiments described above may also be described as the following supplementary notes, but not limited thereto.

(Supplementary Note 1)

A video processing device comprising:

a video acquisition means configured to acquire a material video;

an audience scene extraction means configured to extract an audience scene showing an audience from the material video;

an important scene extraction moans configured to extract an important scene from the material video;

an association means configured to associate the audience scene with the important scene; and

a generation means configured to generate a digest video including the important scene and the audience scene associated with the important scene.

(Supplementary Note 2)

The video processing device according to Supplementary note 1,

wherein the generation means generates the digest video by arranging the important scenes in time series, and

wherein the generation means generates the digest video by arranging the audience scene associated with the important scene before or after the important scene.

(Supplementary Note 3)

The video processing device according to Supplementary note 1 or 2, wherein the association means associates the audience scene existing at a position within a predetermined time before and after the important scene with the important scene.

(Supplementary Note 4)

The video processing device according to any one of Supplementary notes 1 to 3,

wherein the audience scene extraction means extracts information about a color included in the audience scene, and

wherein the association means associates the audience scene with the important scene based on the information about the color.

(Supplementary Note 5)

The video processing device according to any one of Supplementary notes 1 to 3,

wherein the material video is a video of a sport,

wherein the audience scene extraction means extracts a color of a person's clothing or an object carried by people included in the audience scene, and

wherein the association means associates the audience scene with the important scene showing a team that uses the color extracted from the audience scene as a team color.

(Supplementary Note 6)

The video processing device according to any one of Supplementary notes 1 to 5

wherein the audience scene extraction means extracts a character string included in the audience scene, and

wherein the association means associates the audience scene with the important scene based on the character string.

(Supplementary Note 7)

The video processing device according to any one of Supplementary notes 1 to 5

wherein the material video is a video of a sport,

wherein the audience scene extraction means extracts a character string indicated by a message board included in the audience scene or an object worn or carried by a person included in the audience scene, and

wherein the association means associates the audience scene with the important scene showing a team indicated by the character string extracted from the audience scene or a team to which a player indicated by the character string belongs.

(Supplementary Note 8)

The image processing device according to any one of Supplementary notes 1 to 7, wherein the audience scene extraction means extracts the audience scene using a model trained using a training dataset including a training material video prepared in advance and correct answer data indicating an audience scene in the training material video.

(Supplementary Note 9)

A video processing method comprising:

acquiring a material video;

extracting an audience scene showing an audience from the material video;

extracting an important scene from the material video;

associating the audience scene with the important scene; and

generating a digest video including the important scene and the audience scene associated with the important scene.

(Supplementary Note 10)

A recording medium recording a program that causes a computer to perform processing comprising:

acquiring a material video;

extracting an audience scene showing an audience from the material video;

extracting an important scene from the material video;

associating the audience scene with the important scene; and

generating a digest video including the important scene and the audience scene associated with the important scene.

While the present invention has been described with reference to the example embodiments and examples, the present invention is not limited to the above example embodiments and examples. Various changes which can be understood by those skilled in the art within the scope of the present invention can be made in the configuration and details of the present invention.

### DESCRIPTION OF SYMBOLS

2 Material video DB

3 3x Correct answer data

4, 4x Training unit

5, 25 Digest Generation device

12 Processor

21 Audience scene extraction unit

22 Audience scene DB

23 Important scene extraction unit

24 Association unit

100 Digest generation device

200 Training device

What is claimed is:

1. A video processing device comprising:
a memory configured to store instructions; and
one or more processors configured to execute the instructions to:
acquire a material video;
extract an audience scene showing an audience from the material video;
extract an important scene from the material video;
associate the audience scene with the important scene; and
generate a digest video including the important scene and the audience scene associated with the important scene.

2. The video processing device according to claim 1,
wherein the one or more processors generate the digest video by arranging the important scenes in time series, and
wherein the one or more processors generate the digest video by arranging the audience scene associated with the important scene before or after the important scene.

3. The video processing device according to claim 1, wherein the one or more processors associate the audience scene existing at a position within a predetermined time before and after the important scene with the important scene.

4. The video processing device according to claim 1,
wherein the one or more processors extract information about a color included in the audience scene, and
wherein the one or more processors associate the audience scene with the important scene based on the information about the color.

5. The video processing device according to claim 1,
wherein the material video is a video of a sport,
wherein the one or more processors extract a color of a person's clothing or an object carried by people included in the audience scene, and
wherein the one or more processors associate the audience scene with the important scene showing a team that uses the color extracted from the audience scene as a team color.

6. The video processing device according to claim 1,
wherein the one or more processors extract a character string included in the audience scene, and
wherein the one or more processors associate the audience scene with the important scene based on the character string.

7. The video processing device according to claim 1,
wherein the material video is a video of a sport,
wherein the one or more processors extract a character string indicated by a message board included in the audience scene or an object worn or carried by a person included in the audience scene, and
wherein the one or more processors associate the audience scene with the important scene showing a team indicated by the character string extracted from the audience scene or a team to which a player indicated by the character string belongs.

8. The image processing device according to claim 1, wherein the one or more processors extract the audience scene using a model trained using a training dataset including a training material video prepared in advance and correct answer data indicating an audience scene in the training material video.

9. A video processing method comprising:
acquiring a material video;
extracting an audience scene showing an audience from the material video;
extracting an important scene from the material video;
associating the audience scene with the important scene; and
generating a digest video including the important scene and the audience scene associated with the important scene.

10. A non-transitory computer-readable recording medium recording a program that causes a computer to perform processing comprising:
acquiring a material video;
extracting an audience scene showing an audience from the material video;
extracting an important scene from the material video;
associating the audience scene with the important scene; and
generating a digest video including the important scene and the audience scene associated with the important scene.
